(19) United States
(12) Patent Application Publication
(10) Pub. No.: US 2023/0108903 A1
(43) Pub. Date: Apr. 6, 2023

(54) Automated Food Preparation Apparatus

(71) Applicant: Creator, Inc., South San Francisco, CA (US)

(72) Inventors: James Brinkman, South San Francisco, CA (US); Michael BALSAMO, San Francisco, CA (US); Peter Rosenbaum, San Francisco, CA (US); Andrew QUINTANA, San Carlos, CA (US); Maxwell Goodman, Oakland, CA (US); Molly HOELPER, San Carlos, CA (US)

(21) Appl. No.: 17/958,312

(22) Filed: Sep. 30, 2022

Related U.S. Application Data
(60) Provisional application No. 63/233,722, filed on Aug. 16, 2021.
(60) Provisional application No. 63/234,240, filed on Aug. 17, 2021.
(60) Provisional application No. 63/233,724, filed on Aug. 16, 2021.

(51) Int. Cl. A47J 44/00; A47J 37/06; B25J 11/00

(52) U.S. Cl. CPC A47J 44/00; A47J 37/0611; B25J 11/0045; A47J 2037/0617

(57) ABSTRACT

A food preparation apparatus includes a cooker assembly, a food delivery mechanism, a food release mechanism, a food removal mechanism, and a food transport mechanism. The food delivery mechanism includes a first arm and a food vessel mounted to the first arm. The food vessel is configured to deposit a food item onto the cooker assembly. The food release mechanism includes a second arm that is movable between a first position spaced apart from the cooking station and a second position adjacent to a location at which the food vessel deposits the food item onto the cooking station. The food removal mechanism includes a third arm and a set of wipers. The food transport mechanism includes a spatula. The food removal mechanism and the food transport mechanism cooperate to remove the food item from the cooker assembly and transport the food item to a desired location.

### CROSS-REFERENCE TO RELATED APPLICATIONS

This application claims the benefit of U.S. Provisional Application No. 63/233,722 filed Aug. 16, 2021, U.S. Provisional Application No. 63/234,240 filed Aug. 17, 2021, and U.S. Provisional Application No. 63/233,724 filed Aug. 16, 2021. The entire disclosures of the above applications are incorporated by reference.

### FIELD

The present disclosure relates to automated food preparation and more particularly to computer-controlled on-demand food preparation.

### BACKGROUND

Preparation of food items (for example, hamburgers, sandwiches, etc.) according to a consumer’s custom order can be time-consuming and labor-intensive. Furthermore, the process of preparing custom-ordered foodstuffs is susceptible to errors and wide variations in quality. The present disclosure provides an automated food preparation apparatus that can quickly and accurately prepare foodstuffs according to a wide variety of possible custom orders.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An aspect of the present disclosure provides a food preparation apparatus that includes a base, a food delivery mechanism, a food release mechanism, a food removal mechanism, and a food transport mechanism. The food delivery mechanism may be mounted to the base and may include a first arm and a food vessel mounted to the first arm. The food vessel may be configured to contain a food item and may be movable relative to the base to deposit the food item at a selected location. The food release mechanism may be mounted to the base and may include a second arm. The second arm may be movable relative to the selected location between a first position in which the second arm is spaced apart from the selected location and a second position in which the second arm is positioned adjacent to the selected location such that the second arm is configured to contact the food item at the selected location. The food removal mechanism may be mounted to the base and may include a third arm. The food transport mechanism may be mounted to the base and may include a platform. The platform may be movable relative to a cooking assembly between a first position spaced apart from the cooking assembly and a second position adjacent to a cooking station. The third arm may be movable relative to the cooker assembly between a first position spaced apart from the cooker assembly, a second position adjacent to a location at which the food item contacts the cooking station, and a third position in which the third arm is positioned adjacent to the second position of the platform of the food transport mechanism.

In some configurations of the food preparation apparatus of the above paragraph, the third arm may include a wiper configured to make contact with the cooking station during movement between the second position of the third arm and the third position of the third arm.

A food preparation apparatus includes a base and a cooker assembly mounted to the base and including a first cooking station and a second cooking station. The food preparation apparatus includes a food delivery mechanism mounted to the base and including a first arm and a food vessel mounted to the first arm. The food vessel is configured to hold a food item. The food vessel is movable relative to the base and the first cooking station to deposit the food item onto the first cooking station. The food preparation apparatus includes a food release mechanism mounted to the base and including a second arm. The second arm is movable relative to the first cooking station between a first position in which the second arm is spaced apart from the first cooking station and a second position in which the second arm is positioned adjacent to a location at which the food vessel deposits the food item onto the first cooking station. The second arm is configured to contact the food item at the first cooking station while the food item is compressed by the cooker assembly. The food preparation apparatus includes a food removal mechanism mounted to the base and including a third arm. The food preparation apparatus includes a food transport mechanism mounted to the base. The food transport mechanism includes a platform. The platform is movable relative to the second cooking station between a first position in which the platform is spaced apart from the second cooking station and a second position in which the platform is in a position adjacent to the second cooking station. The third arm is movable relative to the second cooking station to push the food item toward the platform of the food transport mechanism. In other features, the third arm includes a wiper configured to make contact with the second cooking station during movement of the third arm.

A food preparation apparatus includes a base and a cooker assembly mounted to the base and including a cooking station. The food preparation apparatus includes a food delivery mechanism mounted to the base and including a first arm and a food vessel mounted to the first arm. The food vessel is configured to hold a food item. The food vessel is movable relative to the base and the cooking station to deposit the food item onto the cooking station. The food preparation apparatus includes a food release mechanism mounted to the base and including a second arm. The second arm is movable relative to the cooking station between a first position in which the second arm is spaced apart from the cooking station and a second position in which the second arm is positioned adjacent to a location at which the food vessel deposits the food item onto the cooking station. The second arm is configured to contact the food item at the cooking station while the food item is compressed by the cooker assembly. The food preparation apparatus includes a food removal mechanism mounted to the base and including a third arm. The food preparation apparatus includes a food transport mechanism mounted to the base. The food transport mechanism includes a platform. The platform is movable relative to the cooking station between a first position in which the platform is spaced apart from the cooking station and a second position in which the platform is in a position adjacent to the cooking station. The third arm is movable relative to the cooking station to push the food item toward the platform of the food transport mechanism. In other features, the third arm includes a wiper configured to make contact with the cooking station during movement of the third arm.

Another aspect of the present disclosure provides a food preparation apparatus may include a base, a cooker assembly, a food delivery mechanism, and a food release mechanism. The cooker assembly may be mounted to the base and includes a cooking station. The food delivery mechanism may be mounted to the base and may include a first arm and a food vessel mounted to the first arm. The food vessel is configured to contain a food item and is movable relative to the base and the cooking station to deposit the food item onto the cooking station. The food release mechanism may be mounted to the base and may include a second arm. The second arm is movable relative to the cooking station between a first position in which the second arm is spaced apart from the cooking station and a second position in which the second arm is positioned adjacent to a location at which the food vessel deposits the food item onto the cooking station. The second arm is configured to contact the food item at the cooking station while the food item is compressed by the cooker assembly.

In some configurations of the food preparation apparatus of the above paragraph, the second arm is rotatable relative to the cooking station about a first rotational axis and about a second rotational axis.

In some configurations of the food preparation apparatus of either of the above paragraphs, the second arm is rotatable about the first rotational axis between the first position and the second position.

In some configurations of the food preparation apparatus of any of the above paragraphs, the first and second rotational axes are perpendicular to each other.

In some configurations of the food preparation apparatus of any of the above paragraphs, the cooker assembly includes a lower cooking surface and an upper griddle head that is movable relative to the lower cooking surface between a raised position and a first lowered position.

In some configurations of the food preparation apparatus of any of the above paragraphs, the food release mechanism includes an actuator configured to rotate the second arm about the first rotational axis.

In some configurations of the food preparation apparatus of any of the above paragraphs, the food delivery mechanism deposits the food item onto the lower cooking surface.

In some configurations of the food preparation apparatus of any of the above paragraphs, in the raised position, the upper griddle head is spaced apart from the food item on the lower cooking surface.

In some configurations of the food preparation apparatus of any of the above paragraphs, in the first lowered position, the upper griddle head contacts the second arm and the food item.

In some configurations of the food preparation apparatus of any of the above paragraphs, the upper griddle head applies a force to the second arm as the upper griddle head moves into the first lowered position that rotates the second arm about the second rotational axis from a non-deflected position to a deflected position.

In some configurations of the food preparation apparatus of any of the above paragraphs, the food release mechanism includes a return mechanism that biases the second arm toward the non-deflected position.

In some configurations, the return mechanism includes one or more of: a spring-loaded plunger, a torsion spring, a leaf spring, an extension spring, a living hinge, an actuator, and magnets.

In some configurations of the food preparation apparatus of any of the above paragraphs, a distal end of the second arm includes a hook. The food item is nested within the hook while the food item is compressed by the cooker assembly.

In some configurations of the food preparation apparatus of any of the above paragraphs, the hook slides axially down an outer diametrical surface of the food item as the second arm moves between the non-deflected position and the deflected position.

In some configurations of the food preparation apparatus of any of the above paragraphs, the second arm includes a contact feature which comes into contact with the upper griddle head as the upper griddle head moves vertically downward such that the upper griddle head applies the force to the contact feature to rotate the second arm about the second rotational axis.

In some configurations of the food preparation apparatus of the above paragraph, the contact feature includes a knob disposed between the hook and the first and second rotational axes.

In some configurations of the food preparation apparatus of any of the above paragraphs, the knob engages the second arm by a snap fit.

In some configurations of the food preparation apparatus of any of the above paragraphs, the upper griddle head is movable among the raised position, the first lowered position and a second lowered position.

In some configurations of the food preparation apparatus of any of the above paragraphs, the first lowered position is disposed vertically between the raised position and the second lowered position.

In some configurations of the food preparation apparatus of any of the above paragraphs, the upper griddle head is movable from the first lowered position to the second lowered position after the second arm disengages the food item.

In some configurations of the food preparation apparatus of any of the above paragraphs, movement of the upper griddle head from the raised position to the second lowered position compresses the food item between the upper griddle head and the lower cooking surface.

In some configurations of the food preparation apparatus of any of the above paragraphs, movement of the upper griddle head from the first lowered position to the second lowered position further compresses the food item between the upper griddle head and the lower cooking surface.

Another aspect of the present disclosure provides a food preparation apparatus that includes a base, a food delivery mechanism, and a food release mechanism. The food delivery mechanism may be mounted to the base and may include a first arm and a food vessel mounted to the first arm. The food vessel may be configured to contain a food item and may be movable relative to the base to deposit the food item at a selected location. The food release mechanism may be mounted to the base and may include a second arm. The second arm may be movable relative to the selected location between a first position in which the second arm is spaced apart from the selected location and a second position in which the second arm is positioned adjacent to the selected location such that the second arm is configured to contact the food item at the selected location.

In some configurations of the food preparation apparatus of the above paragraph, the second arm is rotatable relative to the selected location about a first rotational axis and about a second rotational axis.

In some configurations of the food preparation apparatus of either of the above paragraphs, the second arm is rotatable about the first rotational axis between the first position and the second position.

In some configurations of the food preparation apparatus of any of the above paragraphs, the second arm is rotatable about the second rotational axis between a non-deflected position and a deflected position.

In some configurations of the food preparation apparatus of any of the above paragraphs, the first and second rotational axes are perpendicular to each other.

In some configurations of the food preparation apparatus of any of the above paragraphs, the food release mechanism includes a return mechanism that biases the second arm toward the non-deflected position.

In some configurations of the food preparation apparatus of any of the above paragraphs, the return mechanism includes a spring-loaded plunger.

In some configurations of the food preparation apparatus of any of the above paragraphs, a distal end of the second arm includes a hook.

In some configurations of the food preparation apparatus of any of the above paragraphs, the food item is nested within the hook after the food item has been deposited at the selected location.

In some configurations of the food preparation apparatus of any of the above paragraphs, the hook slides axially down an outer diametrical surface of the food item as the second arm moves between a non-deflected position and a deflected position.

In some configurations of the food preparation apparatus of any of the above paragraphs, the second arm includes a contact feature that extends upward from the second arm.

In some configurations of the food preparation apparatus of any of the above paragraphs, the contact feature includes a knob disposed between the hook and first and second rotational axes about which the second arm is rotatable.

In some configurations of the food preparation apparatus of any of the above paragraphs, the knob engages the second arm by a snap fit.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an plan view of a food preparation apparatus having a food delivery mechanism in a first position, a food release mechanism in a first position, a food removal mechanism in a first position, and a food transport mechanism in a first position;

FIG. 2 is an plan view of the food preparation apparatus with the food delivery mechanism in a second position, the food release mechanism in a second position the food removal mechanism in a second position, and a food transport mechanism in a second position;

FIG. 3 is an plan view of the food preparation apparatus with the food delivery mechanism in the first position, the food release mechanism in the second position, the food removal mechanism in a third position, and a food transport mechanism in the second position;

FIG. 4 is a side view of the food preparation apparatus with an upper griddle head in a raised position and the food release mechanism in the second position;

FIG. 5 is a side view of the food preparation apparatus with the upper griddle head in a food-holding position and an arm of the food release mechanism deflected downward;

FIG. 6 is a side view of the food preparation apparatus with the upper griddle head in a food-cooking position and the food release mechanism in the first position;

FIG. 7 is a perspective view of the food release mechanism;

FIG. 8 is a partial perspective view of the food release mechanism;

FIG. 9 is a perspective view of the food removal mechanism; and

FIG. 10 is a partial perspective view of the food removal mechanism.

In the drawings, reference numbers may be reused to identify similar and/or identical elements.

### DETAILED DESCRIPTION

In an on-demand food production environment, the term on-demand means that the food production is responsive to a demand event, such as a customer placing an order. Another type of demand event is a beginning of a busy time, such as a lunch or dinner rush, or a particular day of high demand. The beginning of a busy time may be estimated based on manual input or automatically based on historical data. In other implementations, the beginning of a busy time may be determined through measurement, such as when the derivative of a moving average of order volume exceeds a defined threshold.

The demand event corresponds to specific customer demand for food items, to satisfy customers’ present desire for food, rather than preparing standard or customized food items ahead of time for eventual consumption. As a result, the time between preparation and consumption of food in an on-demand system may be measured in seconds, minutes, or hours. This is in contrast to industrial food processing in a pre-consumption food production environment, where the time between preparation and consumption may be days, weeks, or even years. Even in an on-demand food production environment, some portions of a food item may be prepared in advance (such as bread for a sandwich).

In an automated on-demand food production environment, a food production apparatus — such as a culinary instrument described below — may be located more closely to the customer, such as in a restaurant or dark kitchen. A dark kitchen is a restaurant that operates no customer seating space or customer pick-up window, instead providing food to customers via first-party and/or third-party delivery services. Locating a culinary instrument nearer to customers, rather than centralizing food production at a factory, may impose size, cost, and maintenance constraints. Further, decentralizing food production may require a culinary instrument that is easier to operate, disassemble, troubleshoot, and clean than factory equipment.

If the culinary instrument will be visible or otherwise exposed to the customer, there may be aesthetic and sanitary considerations in the design of the culinary instrument. In addition, while overall throughput may be important in an industrial pre-consumption food production environment, the elapsed time from demand event to food item completion may be a more important figure of merit for an on-demand food production environment. In various implementations, even an automated food production environment may integrate human contributions, such as to supply ingredients to the culinary instrument, service any interruptions to production by the culinary instrument, and to perform food preparation operations that are not automated. In various implementations, food preparation operations that are more dangerous, more time-consuming, more difficult to perform consistently, or more prone to error may be chosen for automation.

In various implementations, the on-demand food production environment may also be real-time. The term real-time means that a food item is prepared in response to a specific order from a customer so that the food item can be provided to that customer. In various implementations, the food item may be a pre-defined menu item or may have customer-specified features, such as selection and amount of ingredients, doneness level (for example, when cooking meat), manner of assembly (for example, where an ingredient is placed), etc.

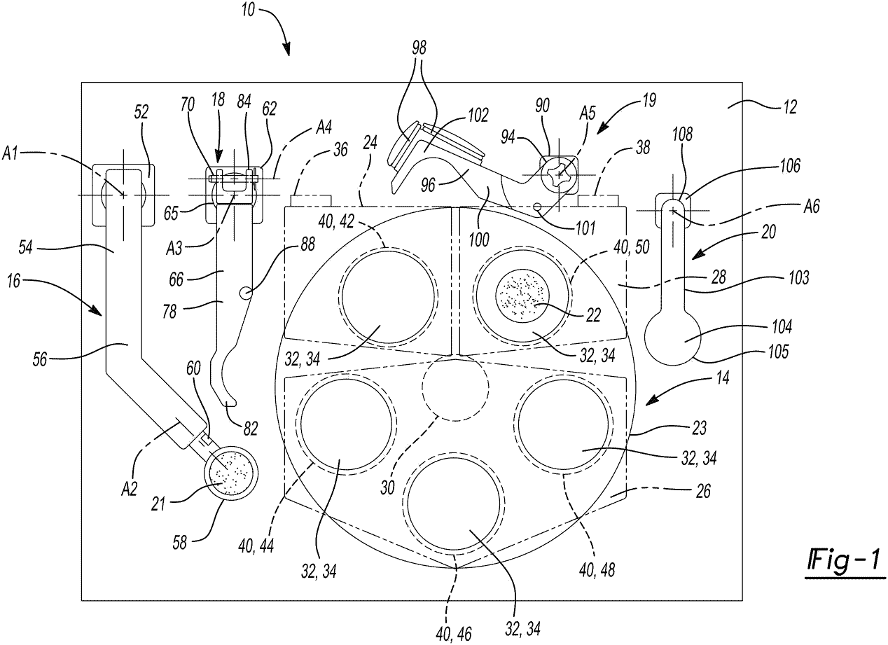

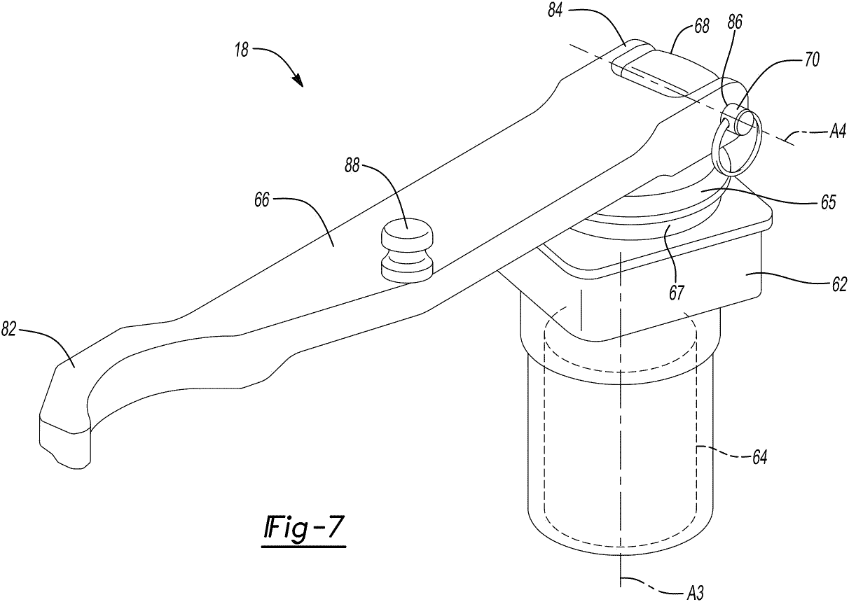

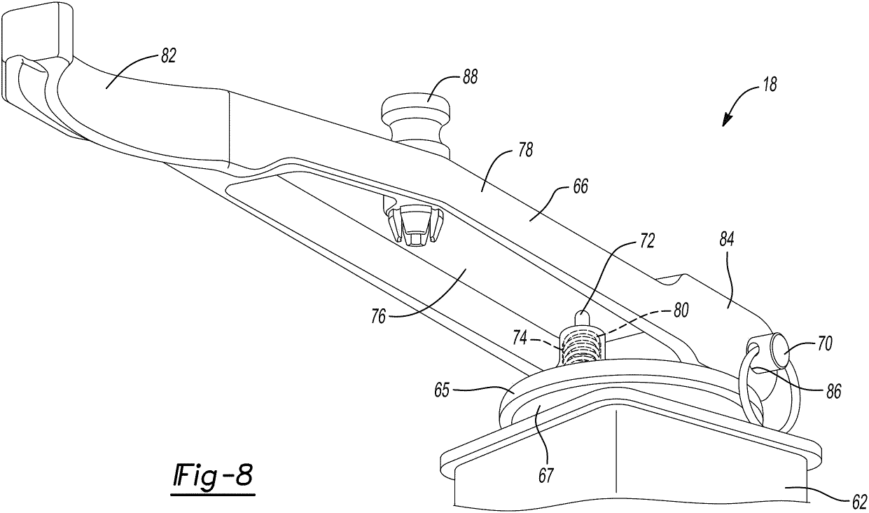

With reference to FIGS. 1-10, a food preparation apparatus 10 (also referred to as a culinary instrument) is provided that may include a base 12, a cooker assembly 14, a food delivery mechanism 16, a food release mechanism 18, a food removal mechanism 19, and a food transport mechanism 20. As will be described in more detail below, the food delivery mechanism 16 may receive food product (e.g., ground meat, vegetable-based food, and/or grain-based food) from a food grinder or other food reservoir or source. In various implementations, the food product may be a source of protein and may be seasoned or marinated, such as with salt, pepper, or seasonings from a Hamburger Helper packaged food product.

The food delivery mechanism 16 may transport the food product from the grinder (or other source) to the cooker assembly 14. The food product may be deposited onto the cooker assembly 14 in the form of a patty 21, for example. The food release mechanism 18 may aid in separating the patty 21 from the food delivery mechanism 16 and maintaining a desired positioning of the patty 21 on the cooker assembly 14. The cooker assembly 14 may cook the patty 21 according to a desired level of doneness. The food removal mechanism 19 may aid in moving a fully cooked patty 22 from the cooker assembly 14 to the food transport mechanism 20. The food transport mechanism 20 may transport the completed patty 22 from the cooker assembly 14 to a desired location (e.g., to a tray containing a hamburger bun and toppings, for example).

The cooker assembly 14 may be a griddle assembly, for example, or any other type of cooking device (e.g., an oven, fryer, grille, etc.). The cooker assembly 14 may cook a single patty (e.g., a meat or other food patty) or multiple patties at a time. The cooker assembly 14 may include features and functions that are the same as or similar to the features and functions of the cooking systems described in Assignee’s commonly owned U.S. Pat. Application Publication No. 2019/0298104, the disclosure of which is hereby incorporated by reference.

As schematically shown in FIGS. 1-6, the cooker assembly 14 may be mounted to the base 12 and may include a lower griddle hub 23, a first upper griddle head 24, a second upper griddle head 26, a third upper griddle head 28. The griddle hub 23 may be rotatably mounted to the base 12. A motor 30 (FIGS. 1-3) may rotate the griddle hub 23 relative to the base 12 and the upper griddle heads 24, 26, 28. A plurality of lower cooking plates (or surfaces) 32 may be mounted to the hub for rotation with the hub 23 relative to the base 12 and the upper griddle heads 24, 26, 28. Each of the upper griddle heads 24, 26, 28 may have one or more upper cooking plates (or surfaces) 34. The total number of upper cooking plates 34 matches the total number of lower cooking plates 32 such that each of the lower cooking plates 32 can be aligned with a corresponding one of the upper cooking plates 34. The cooking plates 32, 34 may be heated by lower induction coils 40 and upper induction coils 42, 44, 46, 48, 50. In some configurations, the induction coils 40, 42, 44, 46, 48, 50 can be replaced with other types of heating elements such as resistive heating elements, radiant heating elements, infrared heating elements, convection heating elements, conductive heating elements, or burners, for example.

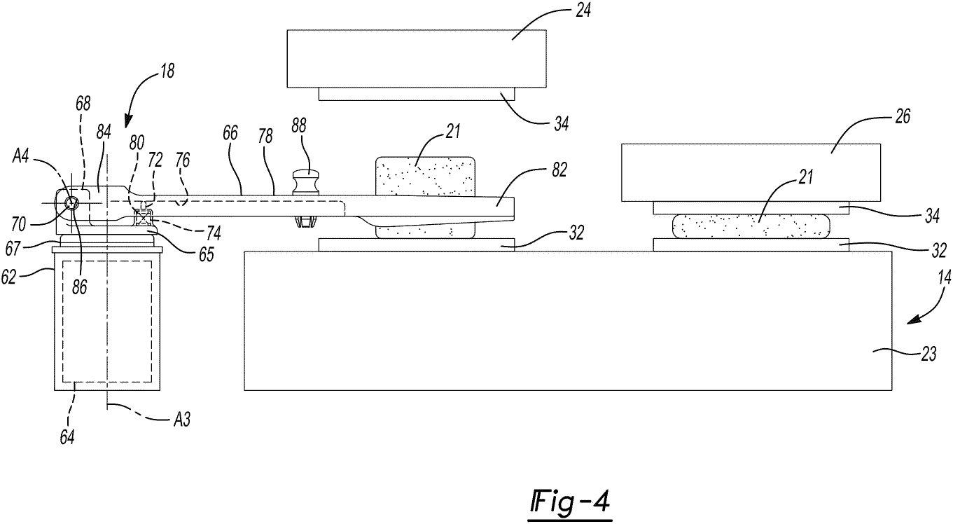

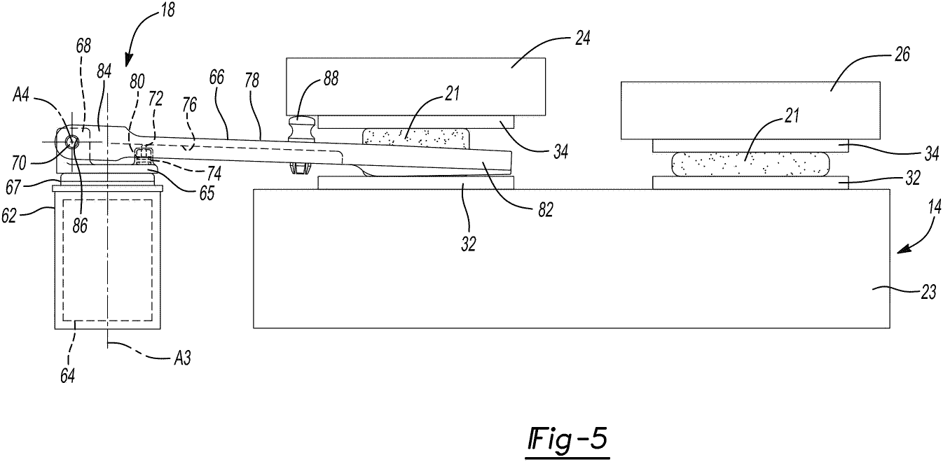

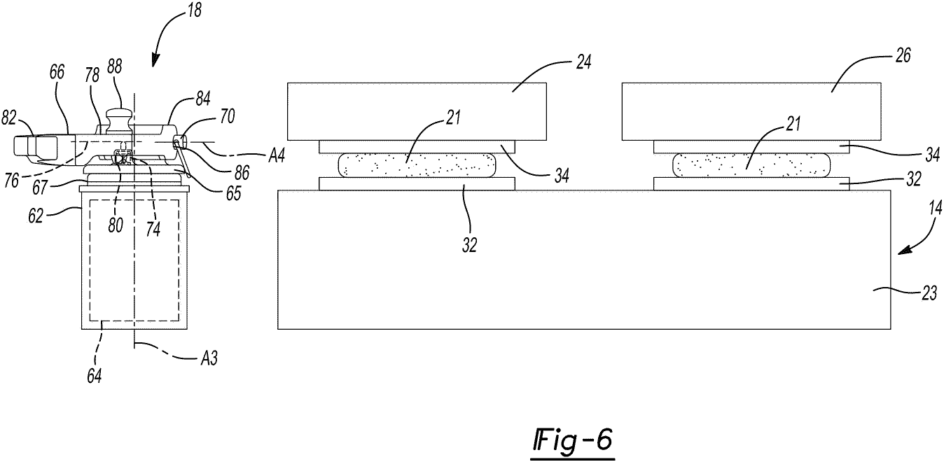

A first actuator 36 (shown schematically in FIGS. 1-3) may be mounted to the base 12 and coupled to the first upper griddle head 24. The first actuator 36 may be configured to move the first upper griddle head 24 vertically up and down relative to the hub 23 among a first position (i.e., a raised position shown in FIG. 4), a second position (i.e., a food-holding position or first lowered position shown in FIG. 5), and a third position (i.e., a food-cooking position or second lowered position shown in FIG. 6). The first actuator 36 can be any type of actuator configured to move the first upper griddle head 24 vertically up and down. For example, the first actuator 36 may include a tower (e.g., one or more elongated beams or rods), a block, and a motor. The tower may be fixedly mounted to the base 12 and may extend vertically upward from the base 12. The block may be movably mounted on the tower. The first upper griddle head 24 may be fixed to the block. The motor may be mounted on the tower and is connected to the block (e.g., via a spindle and nut). The motor may selectively drive the block and the first upper griddle head 24 vertically up and down the tower. It will be appreciated that the first actuator 36 could be any suitable type of electromechanical, electromagnetic, pneumatic, or hydraulic actuator, for example.

A second actuator 38 (shown schematically in FIGS. 1-3) may be mounted to the base 12 and coupled to the third upper griddle head 28. The second actuator 38 may be configured to move the third upper griddle head 28 vertically up and down relative to the hub 23. The second actuator 38 can be similar or identical to the first actuator 36.

The first, second, and third upper griddle heads 24, 26, 28 define a plurality of cooking stations. That is, the first upper griddle head 24 defines a first cooking station (or an entry or input cooking station) at the first upper induction coil 42 (or other first upper heating element); the second upper griddle head 26 defines second, third, and fourth cooking stations (or intermediate cooking stations) at the second, third, and fourth upper induction coils 44, 46, 48 (or other second, third, and fourth upper heating element); and the third upper griddle head 28 defines a fifth cooking station (or an exit or output cooking station) at the fifth upper induction coil 50 (or other fifth upper heating element). The motor 30 can selectively rotate the hub 23 to move the lower cooking plates 32 and the upper cooking plates 34 in a counterclockwise direction relative to the upper induction coils 42, 44, 46, 48, 50 among the plurality of cooking stations. It will be appreciated that while the food preparation apparatus 10 shown in the figures includes five cooking stations, in some embodiments, the apparatus 10 could include fewer or more than five cooking stations.

The food delivery mechanism 16 can be a robotic arm, for example, and may be configured to receive food product from a food source (e.g., a food grinder) and deposit the food product in the form of the patty 21 onto the lower cooking plate 32 at the input cooking station while the first upper griddle head 24 is in the raised position. The food delivery mechanism 16 may include features and functions that are the same as or similar to the features and functions of the arm assemblies described in Assignee’s commonly owned U.S. Pat. Application Publication No. 2020/0101469, the disclosure of which is hereby incorporated by reference.

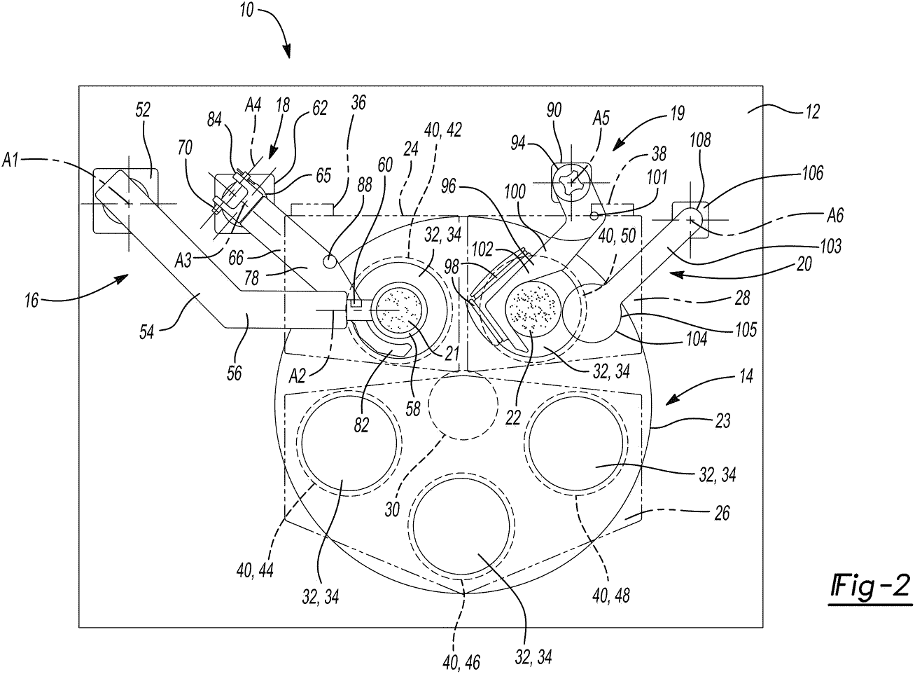

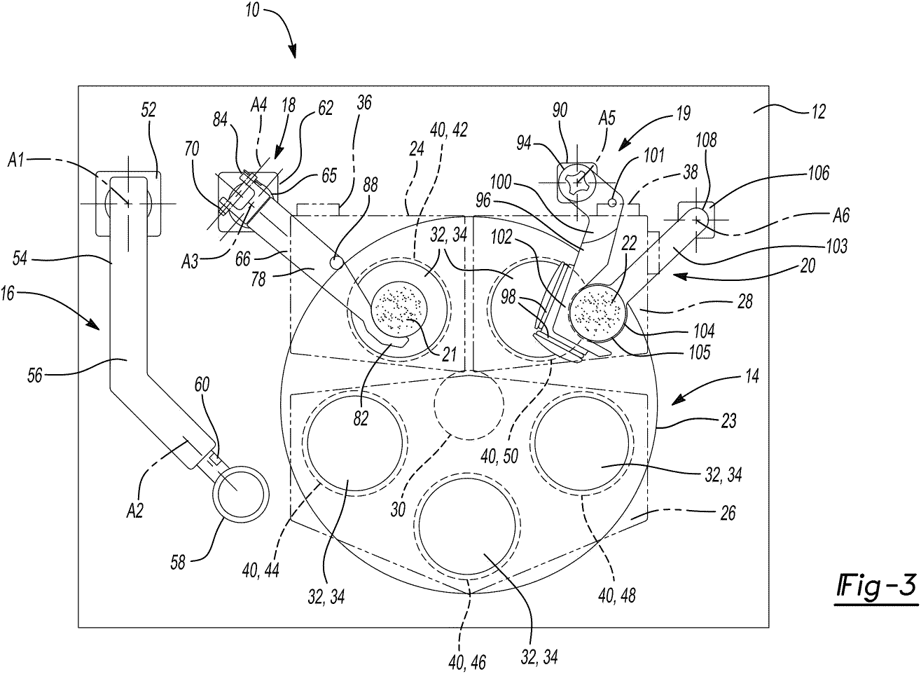

As shown schematically in FIGS. 1-3, the food delivery mechanism 16 may be mounted to the base 12 and may include an actuator 52, an arm (e.g., including first arm portion 54 and a second arm portion 56), and a food vessel. The food vessel may be a cylinder 58 (with a circular or oval cross-sectional shape, for example) or other container having any suitable shape, such as hemispherical, frustoconical, rectangular prism, for example. The actuator 52 may include a motor and gearset, for example. A first end of the first arm portion 54 may be pivotably connected to the actuator 52. The second arm portion 56 may extend from a second end of the first arm portion 54. In some configurations, the second arm portion 56 may be pivotably connected to the first arm portion 54. While the first and second arm portions 54, 56 are shown as being angle relative to each other, in some configurations, the arm portions 54, 56 can form a generally straight arm. The cylinder 58 (or food vessel of any other shape) may be rotatably connected to the second arm portion 56. The actuator 52 may be configured to rotate the first arm portion 54, second arm portion 56, and cylinder 58 relative to the base 12 about a first rotational axis A1 between a first position (FIGS. 1 and 3) and a second position (FIG. 2). In the second position, the cylinder 58 is disposed above the lower cooking plate 32 of the cooker assembly 14.

Another motor 60 may be mounted to the second arm portion 56. The motor 60 may rotate the cylinder 58 relative to the first and second arm portions 54, 56 about a second rotational axis A2. In this manner, the motor 60 may rotate the cylinder 58 about the second rotational axis A2 between an upright position (in which the cylinder 58 receives and carries the patty 21) and an inverted position to allow the patty 21 in the cylinder 58 to be deposited onto the lower cooking plate 32 of the cooker assembly 14. In some configurations, the motor 60 may also move a piston (not shown) within the cylinder 58 to push the patty 21 out of the cylinder 58 (while the cylinder 58 is in the inverted position) and onto the lower cooking plate 32. In some configurations, compressed air may be provided to assist in forcing the patty 21 out of the cylinder 58 while the cylinder 58 is in the inverted position.

As described above, the food release mechanism 18 may aid in separating the patty 21 from the food delivery mechanism 16 and maintaining a desired positioning of the patty 21 on the cooker assembly 14. The food release mechanism 18 may be mounted to the base 12 and may include a base 62, an actuator 64 (shown schematically in FIGS. 4-7), a turret 65, and an arm 66. The base 62 may be fixedly mounted to the base 12 of the apparatus 10 (FIGS. 1-3). The actuator 64 may be disposed within the base 62 and may include a motor and a gearset, for example. The actuator 64 may be connected to the turret 65 and is configured to rotate the turret 65 and the arm 66 relative to the base 62 and the hub 23 about a third rotational axis A3 between a first position in which the arm 66 is spaced apart from a first cooking station (FIGS. 1 and 6) and a second position in which the arm 66 is positioned adjacent to the location at which the food delivery mechanism 18 deposits the patty 21 (FIGS. 2-5). An annular seal 67 (FIGS. 4-8) may sealingly engage the turret 65 and the base 62 to prevent food product, other debris, and liquids from entering the base 62.

The turret 65 is rotatably coupled to the base 62 (for rotation relative to the base 62 about the third rotational axis A3). The arm 66 is coupled to the turret 65 and is rotatably relative to the turret 65 about a fourth rotational axis A4 between a first position (i.e., a non-deflected position shown in FIG. 4) and a second position (i.e., a deflected position shown in FIG. 5). The turret 65 may include a protrusion 68 (FIGS. 4-7) having an aperture extending therethrough. A pin 70 may extend through the aperture in the turret 65 and through apertures in the arm 66 to rotationally connect the arm 66 to the turret 65. The pin 70 may define the fourth rotational axis A4.

The food release mechanism 18 may include a return mechanism that biases the arm 66 upward toward the non-deflected position. For example, the return mechanism may include a spring-loaded plunger 72 (shown in FIGS. 4-6 and 8) that is reciprocatingly received in a cavity 74 in the turret 65. A tip of the plunger 72 may contact a surface 76 of a body 78 of the arm 66 (i.e., the body 78 of the arm 66 rests on the tip of the plunger 72). A spring 80 (e.g., a compression spring) disposed within the turret 65 biases the plunger 72 vertically upward to bias the arm 66 toward the non-deflected position (FIG. 4). A vertically downward force applied to the arm 66 to move the arm into the deflected position (FIG. 5) may compress the spring 80 and move the plunger 72 into the cavity 74. In some configurations, the return mechanism could be or include a torsion spring, a leaf spring, an extension spring, a living hinge, an actuator, magnets, pneumatics, and/or hydraulics (instead of or in addition to the spring 80 and/or plunger 72) that bias the arm 66 upward toward the non-deflected position.

The arm 66 may be formed from a heat-resistant material (e.g., a ceramic or metallic material). The heat-resistant material of the arm 66 may be a non-stick (or low-stick) material, or the arm 66 may be coated with a non-stick or low-stick material such as polytetrafluoroethylene (PTFE), for example. The arm 66 may include the body 78, a hook 82, and a clevis 84.

The hook 82 provides a surface to engage an object — such as a food product, described below — and resist movement of the object. As a result, a shape and size of the hook 82 may be dictated by the shape and size of the object(s) the hook 82 will encounter. In various implementations, the hook 82 may have a flat, concave, or angular surface. For example, the angular surface may be wedge-shaped and formed by two flat surfaces with an acute angle between them. In other implementations, the surface of the hook 82 may be arcuate — for example, the surface may form an arc that subtends less than 180 degrees.

The hook 82 may extend from one end of the body 78 of the arm 66, and the clevis 84 may extend from the opposite end of the body 78. The protrusion 68 may be received between the legs of the clevis 84. The pin 70 may extend through apertures 86 formed in the legs of the clevis 84 and through the aperture in the protrusion 68 to rotatably couple the arm 66 to the turret 65.

The arm 66 may include a knob 88 (or another contact feature such as a protrusion or boss, for example) formed on or attached to the arm 66. For example, the knob 88 may be formed from a polymeric material and may snap into an aperture in the body 78 of the arm 66. The knob 88 may extend vertically upward from the body 78. When the arm 66 is in the second position (FIGS. 2-5) and the food delivery mechanism 16 is in the first position (after the food delivery mechanism 16 deposits the patty 21 onto the lower cooking plate 32, as shown in FIG. 3), the first upper griddle head 24 may move from the raised position to the food-holding position (see FIGS. 4 and 5). During movement of the first upper griddle head 24 from the raised position (FIG. 4) to the food-holding position (FIG. 5), the first upper griddle head 24 may contact the knob 88 (or other contact feature) and force the arm 66 to rotate downward about the rotational axis A4 to the deflected position (FIG. 5). The spring-loaded plunger 72 (or other return mechanism) may force the arm 66 to rotate about the rotational axis A4 back to the non-deflected position once the knob 88 clears the first upper griddle head 24 during movement of the arm 66 (i.e., during rotational of the arm 66 about the rotational axis A3) toward the position shown in FIG. 6.

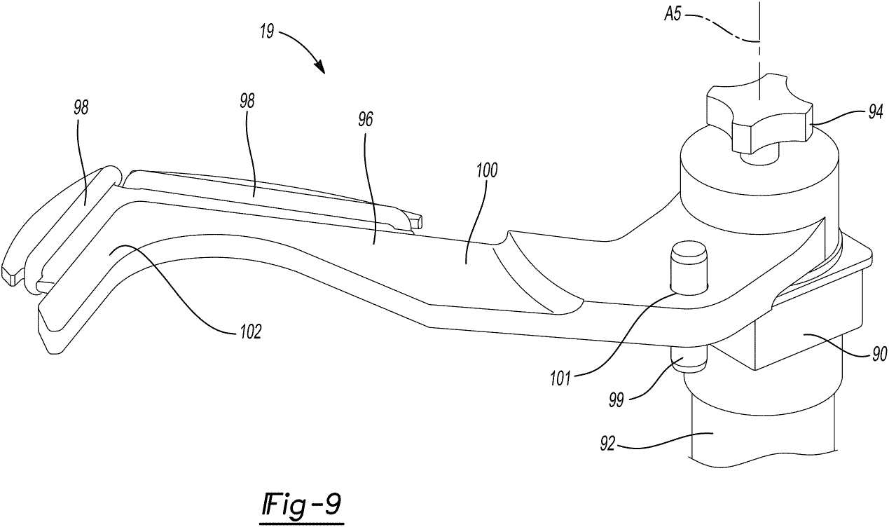

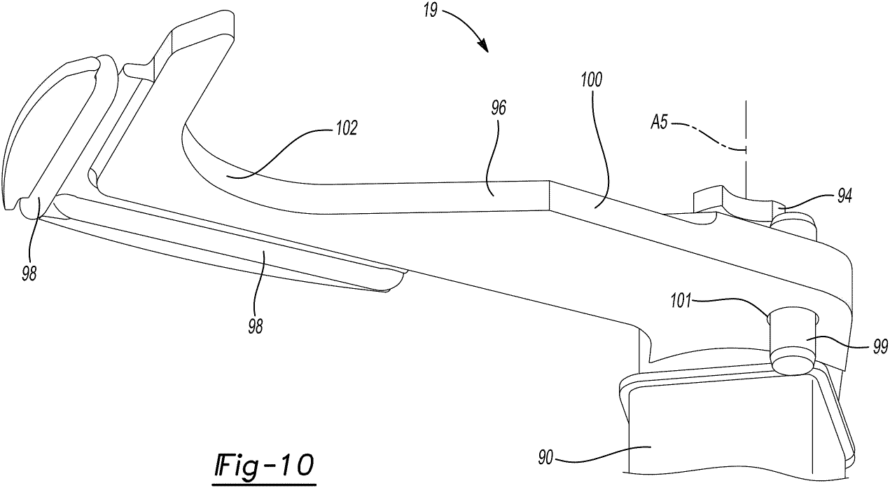

The food removal mechanism 19 may aid in separating the completed patty 22 from the cooker assembly 14. The food removal mechanism 19 may be mounted to the base 12 and may include a base 90, an actuator 92 (shown schematically in FIG. 9), a turret 94, an arm 96, and a wiper or a set of wipers 98. The base 90 may be fixedly mounted to the base of the apparatus (FIGS. 1-3). The actuator 92 may be disposed within the base 90 and may include a motor and a gearset, for example. The actuator 92 may be connected to the turret 94 and is configured to rotate the turret 94 and the arm 96 relative to the base 90 and the hub 23 about a fifth rotational axis A5 between a first position (FIG. 1), a second position (FIG. 2), and a third position (FIG. 3). An annular seal (FIGS. 9-10) may sealingly engage the turret 94 and the base 90 to prevent food product, other debris, and liquids from entering the base 90. The turret 94 is rotatably coupled to the base 90 (for rotation relative to the base 90 about the fifth rotational axis A5).

The arm 96 may be formed from a heat-resistant material (e.g., a ceramic or metallic material). The heat-resistant material of the arm 96 may be a non-stick (or low-stick) material, or the arm 96 may be coated with a non-stick or low-stick material such as polytetrafluoroethylene (PTFE), for example. The arm 96 may include a body 100 and a hook 102. The body 100 may be attached to the turret 94 for rotation with the turret 94 about the fifth rotational axis A5. The hook 102 may extend from a distal end of the body 100 of the arm 96 (i.e., an end of the body 100 opposite the turret 94). The set of wipers 98 may be to the outside diameter of the hook 102, configured in such a way to wipe away residue from a surface below the arm 96. The set of wipers 98 may be or include rubber O-rings, plastic fingers, or any other wiping feature.

As shown in FIGS. 9 and 10, the arm 96 may include an aperture 101 configured to removably receive a pin 99 (e.g., a dowel rod or other protrusion). The pin 99 may be inserted into the aperture 101 in the event that the actuator 92 is disabled or inoperable. In such circumstances, the pin 99 may be inserted into the aperture 101 (e.g., by press fit, snap fit, etc.) such that the pin 99 extends downward from the arm 96 to engage a stop feature (e.g., a pocket or blocking feature; not shown) formed on or in the base 12. When the pin 99 is engaged with the stop feature, the arm 96 is rotationally locked in the second position (i.e., the position shown in FIG. 2). When the actuator 92 is fully operational (i.e., operating correctly), the pin 99 is removed from the aperture 101 so that the arm 96 has its full range of motion among the positions shown in FIGS. 1-3.

The food transport mechanism 20 may be mounted to the base 12 and may include a spatula 104, a base 106, an actuator (not shown), and a turret 108. The base 106 may be fixedly mounted to the base of the apparatus (FIGS. 1-3). The actuator may be disposed within the base 106 and may include a motor and a gearset, for example. The actuator may be connected to the turret 108 and is configured to rotate the turret 108 and the spatula 104 relative to the base 106 and the hub 23 about a sixth rotational axis A6 between a first position in which the spatula 104 is spaced apart from a second cooking station (FIG. 1) and a second position in which the spatula 104 is positioned adjacent to the second cooking station (FIGS. 2 and 3).

The spatula 104 may be formed from a heat-resistant material (e.g., a ceramic or metallic material). The heat-resistant material of the spatula 104 may be a non-stick (or low-stick) material, or the platform may be coated with a non-stick or low-stick material such as polytetrafluoroethylene (PTFE), for example. The spatula 104 may include an arm 103 and a generally flat platform 105 large enough to support the competed patty 22 and thin enough to be slid underneath the patty 22. A first end of the arm 103 may be attached to the turret 108 and a second end of the arm 103 may be attached to the platform 105. In some configurations, the food transport mechanism 20 may be or include the spatula assembly disclosed in Assignee’s commonly owned U.S. Pat. Application Publication No. 2019/0298104, the disclosure of which is hereby incorporated by reference.

With continued reference to FIGS. 1-10, operation of the food preparation apparatus 10 will be described in detail. The cylinder 58 of the food delivery mechanism 16 may receive food product (e.g., ground meat, vegetable-based food, and/or grain-based food) from a food grinder or other food reservoir or source. With the first upper griddle head 24 in the raised position, the food delivery mechanism 16 may rotate the arm portions 54, 56 of the food delivery mechanism 16 about the rotational axis A1 to position the cylinder 58 above the lower cooking plate 32 at the input cooking station (as shown in FIG. 2). With the arm 66 of the food release mechanism 18 in the second position (i.e., the position shown in FIGS. 2 and 3), the food delivery mechanism 16 may rotate the cylinder 58 about the rotational axis A2 to allow the food product in the cylinder 58 to fall out of the cylinder 58 onto the lower cooking plate 32 (at the input cooking station) in the form of the patty 21. When the patty 21 drops onto the lower cooking plate 32, the patty 21 may be nested within the hook 82 of the arm 66. In other words, the curvature of the hook 82 may partially surround the outer diameter of the patty 21. In some configurations, the inner diameter of the hook 82 may be larger than the outer diameter of the patty 21 to reduce contact surface area between the hook 82 and the patty 21, which may reduce sticking between the patty 21 and the hook 82.

Contact between the patty 21 and the hook 82 may aid in separating the patty 21 from the cylinder 58. That is, friction between the hook 82 and the outer diameter of the patty 21 may counteract any sticking of the patty 21 to the cylinder 58. The hook 82 may also help to maintain a desired positioning of the patty 21 on the lower cooking plate 32 as the arm portions 54, 56 and cylinder 58 of the food delivery mechanism 16 move about the rotational axis A1 from the position shown in FIG. 2 to the position shown in FIG. 3.

Then, the first upper griddle head 24 may move from the raised position to the food-holding position (see FIGS. 4 and 5). During movement of the first upper griddle head 24 from the raised position (FIG. 4) to the food-holding position (FIG. 5), the first upper griddle head 24 may contact the knob 88 (or other contact feature) and force the arm 66 to rotate downward about the rotational axis A4 to the deflected position (FIG. 5) while simultaneously compressing the patty 21 between the lower and upper cooking plates 32, 34. This downward motion of the arm 66 relative to the patty 21 while the first upper griddle head 24 moves into the food-holding position allows the hook 82 to be sheared out of sticking contact with the patty 21. In other words, the downward motion of the arm 66 helps to unstick the hook 82 from the patty 21. The downward pressure of the first upper griddle head 24 on the patty 21 in the food-holding position helps to maintain the position of the patty 21 on the lower cooking plate 32 as the arm 66 rotates back to the position shown in FIG. 6. In other words, the first upper griddle head 24 holds the patty 21 in place as the arm 66 rotates away from the patty 21. Once the knob 88 on the arm 66 is moved clear of the first upper griddle head 24, the return mechanism returns the arm 66 to the non-deflected position and the first upper griddle head 24 can move from the food-holding position to the food-cooking position (FIG. 6) to further compress the patty 21 to a desired thickness.

The cooker assembly 14 may then cook the patty 21 according to a desired level of doneness. That is, the upper and lower induction coils 40, 42 at the input cooking station can be energized to cook the patty for a selected amount of time before the motor 30 rotates the hub 23 to move the lower and upper plates 32, 34 counterclockwise to move the patty 21 sequentially to each of the intermediate cooking stations and the exit cooking station for additional cooking for selected amounts of time. If desired, after the patty 21 is moved out of the input cooking station, the food delivery mechanism 16 can deliver another patty to the input cooking station. In this manner, the cooker assembly 14 can cook multiple patties at the same time.

After the cooker assembly 14 has cooked the patty to a desired level of doneness, the food removal mechanism 19 may move from the first position to the second position to engage the competed patty 22 by rotating the arm 96 about the rotational axis A5. In the second position, the completed patty 22 may be nested within the hook 102 of the arm 96 of the food removal mechanism 19. While the arm 96 is moving to the second position (or after the arm 96 arrives at the second position), the food transport mechanism 20 may move from its first position to its second position by rotating the spatula 104 about the rotational axis A6. Thereafter, the food removal mechanism 19 may begin to move to the third position by rotating the spatula 104 about the rotational axis A5. In the movement from the second position to the third position, the food removal mechanism 19 may advance the completed patty 22 off the cooker assembly 14 and onto the platform 105 of the food transport mechanism 20. Pushing the patty 22 onto the platform 105 with the food removal mechanism 19 may improve pickup consistency of completed patties and may help to disengage the patty 22 from the cooking plate 32 (i.e., if the patty 22 sticks to the cooking plate 32 during the cooking process.

Furthermore, during the movement of the food removal mechanism 19 from the second position to the third position, the set of wipers 98 of the food removal mechanism 19 may make contact with the upper cooking surface 34 and lower cooking surface 32 such that the wipers 98 can wipe any grease or char from the upper cooking surface 34 and/or the lower cooking surface 32, which may improve the quality of subsequent patties. In addition, removal of the char or grease may reduce sticking between subsequent patties and the cooking plates 32, 34 and may minimize time needed to clean the cooker assembly 14 outside of operation.

In some situations, a patty may have been cooked incorrectly and must be discarded or must be purged for another reason. In these situations, the food removal mechanism 19 may move from the first position to the second position to engage the undesired patty by rotating about the rotational axis A5. The undesired patty may be nested within the hook 102 of the arm 96 of the food removal mechanism 19. After engaging the patty, the food removal mechanism 19 may begin to move to the third position by rotating the arm 96 about the rotational axis A5. In this situation, the food transport mechanism 20 may remain in the first position as the food removal mechanism 19 moves to the third position. The undesired patty may then be moved by the food removal mechanism 19 to a waste receptacle or other disposal space to avoid contaminating the food transport mechanism 20.

In some embodiments, the arm of the food removal mechanism 19 may have a plurality of pivot points, allowing movement in different directions and/or movement about multiple rotational axes.

In some embodiments, the arm of the food removal mechanism 19 may include a temperature probe, which may sense the temperature of the completed patty 22 before removal from the cooker assembly 14.

In some embodiments, the food removal mechanism 19 may include a linkage (e.g., a four-bar linkage) that could wipe surfaces of the cooking plates 32, 34 at the output cooking station.

One or more control modules may be in communication with the cooker assembly 14, the food delivery mechanism 16, the food release mechanism 18, the food removal mechanism 19, and the food transport mechanism 20. The control module(s) may control operation of the cooker assembly 14, the food delivery mechanism 16, the food release mechanism 18, the food removal mechanism 19, and the food transport mechanism 20 in the manner described above.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. The phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A food preparation apparatus comprising:
a base;
a cooker assembly mounted to the base and including a cooking station;
a food delivery mechanism mounted to the base and including a first arm and a food vessel mounted to the first arm, wherein the food vessel is configured to contain a food item and is movable relative to the base and the cooking station to deposit the food item onto the cooking station; and
a food release mechanism mounted to the base and including a second arm, wherein the second arm is movable relative to the cooking station between a first position in which the second arm is spaced apart from the cooking station and a second position in which the second arm is positioned adjacent to a location at which the food vessel deposits the food item onto the cooking station,
wherein the second arm is configured to contact the food item at the cooking station while the food item is compressed by the cooker assembly.

2. The food preparation apparatus of claim 1, wherein:
the second arm is rotatable relative to the cooking station about a first rotational axis and about a second rotational axis,
the second arm is rotatable about the first rotational axis between the first position and the second position, and
the first and second rotational axes are perpendicular to each other.

3. The food preparation apparatus of claim 2, wherein:
the cooker assembly includes a lower cooking surface and an upper griddle head that is movable relative to the lower cooking surface between a raised position and a first lowered position, and
the food release mechanism includes an actuator configured to rotate the second arm about the first rotational axis.

4. The food preparation apparatus of claim 3, wherein:
the food delivery mechanism deposits the food item onto the lower cooking surface,
in the raised position, the upper griddle head is spaced apart from the food item on the lower cooking surface,
in the first lowered position, the upper griddle head contacts the second arm and the food item, and
the upper griddle head applies a force to the second arm as the upper griddle head moves into the first lowered position that rotates the second arm about the second rotational axis from a non-deflected position to a deflected position.

5. The food preparation apparatus of claim 4, wherein the food release mechanism includes a return mechanism that biases the second arm toward the non-deflected position.

6. The food preparation apparatus of claim 5, wherein the return mechanism includes a spring-loaded plunger.

7. The food preparation apparatus of claim 4, wherein:
a distal end of the second arm includes a hook, and
the food item is nested within the hook while the food item is compressed by the cooker assembly.

8. The food preparation apparatus of claim 7, wherein the hook slides axially down an outer diametrical surface of the food item as the second arm moves between the non-deflected position and the deflected position.

9. The food preparation apparatus of claim 7, wherein the second arm includes a contact feature which comes into contact with the upper griddle head as the upper griddle head moves vertically downward such that the upper griddle head applies the force to the contact feature to rotate the second arm about the second rotational axis.

10. The food preparation apparatus of claim 9, wherein the contact feature includes a knob disposed between the hook and the first and second rotational axes.

11. The food preparation apparatus of claim 10, wherein the knob engages the second arm by a snap fit.

12. The food preparation apparatus of claim 4, wherein:
the upper griddle head is movable among the raised position, the first lowered position and a second lowered position,
the first lowered position is disposed vertically between the raised position and the second lowered position,
the upper griddle head is movable from the first lowered position to the second lowered position after the second arm disengages the food item,
movement of the upper griddle head from the raised position to the second lowered position compresses the food item between the upper griddle head and the lower cooking surface, and
movement of the upper griddle head from the first lowered position to the second lowered position further compresses the food item between the upper griddle head and the lower cooking surface.

13. A food preparation apparatus comprising:
a base;
a food delivery mechanism mounted to the base and including a first arm and a food vessel mounted to the first arm, wherein the food vessel is configured to contain a food item and is movable relative to the base to deposit the food item at a selected location; and
a food release mechanism mounted to the base and including a second arm, wherein the second arm is movable relative to the selected location between a first position in which the second arm is spaced apart from the selected location and a second position in which the second arm is positioned adjacent to the selected location such that the second arm is configured to contact the food item at the selected location.

14. The food preparation apparatus of claim 13, wherein:
the second arm is rotatable relative to the selected location about a first rotational axis and about a second rotational axis,
the second arm is rotatable about the first rotational axis between the first position and the second position,
the second arm is rotatable about the second rotational axis between a non-deflected position and a deflected position, and
the first and second rotational axes are perpendicular to each other.

15. The food preparation apparatus of claim 14, wherein the food release mechanism includes a return mechanism that biases the second arm toward the non-deflected position.

16. The food preparation apparatus of claim 15, wherein the return mechanism includes a spring-loaded plunger.

17. The food preparation apparatus of claim 13, wherein:
a distal end of the second arm includes a hook, and
the food item is nested within the hook after the food item has been deposited at the selected location.

18. The food preparation apparatus of claim 17, wherein the hook slides axially down an outer diametrical surface of the food item as the second arm moves between a non-deflected position and a deflected position.

19. The food preparation apparatus of claim 17, wherein the second arm includes a contact feature that extends upward from the second arm.

20. The food preparation apparatus of claim 19, wherein:
the contact feature includes a knob disposed between the hook and first and second rotational axes about which the second arm is rotatable; and
the knob engages the second arm by a snap fit.
